(19) United States
(12) Patent Application Publication
(10) Pub. No.: US 2003/0081216 A1
(43) Pub. Date: May 1, 2003

(54) Graphical user interface for sample positioning

(76) Inventors: Martin Ebert, Fremont, CA (US); Ilya Chizhov, Oakland, CA (US)

Correspondence Address: STALLMAN & PLLOCK LLP, 121 Spear Street, Suite 290, San Francisco, CA, 94105, US

(21) Appl. No.: 10/096,143

(22) Filed: Mar. 8, 2002

Related U.S. Application Data
(60) Provisional application No. 60/336,561, filed on Nov. 1, 2001.

(51) Int. Cl. G01N 21/55

(52) U.S. Cl. 356/445

(57) ABSTRACT

A metrology system which includes an imaging system and provides a number of software interface tools. These software interface tools allow a user to intuitively and efficiently move a sample being imaged and measured to different locations relative to the imaging system. The software interface allows a user to use a pointer to select areas on an image of the wafer, and the processor system will detect the user inputs selecting the desired area on the wafer, and in response to the input, move the selected area on the wafer to a position such that it appears closer to a center region displayed on the user interface. The software interface also provides a geometric shape where the user can select areas on the geometric shape and in response to the selection of areas on the geometric shape the processor system will move a corresponding area on the wafer being imaged to a location relative to the imaging system such that the corresponding area will appear closer to a center area on a displayed image of the wafer.

### RELATED APPLICATION

The present application claims the benefit of U.S. Provisional Application Serial No. 60/336,561 filed Nov. 1, 2001, titled WAFER POSITIONING VIA GRAPHICAL USER INTERFACE (attorney docket TWI-16800) which is incorporated herein by reference.

### TECHNICAL FIELD

The present invention relates to the field of metrology tools used to analyze semiconductor wafers. Specifically, the present invention pertains to a user interface for positioning the sample being analyzed so that specific areas of the wafer can be studied.

### BACKGROUND

This invention relates to optical metrology tools of the type described in U.S. Pat. No. 6,278,519, which is hereby incorporated herein by reference. These tools are used to analyze characteristics of a sample, which typically consists of a semiconductor wafer. A view of an optical metrology system is shown in FIG. 1. This system includes one or more probe beams 102, generated by energy sources 103, which are focused on an area 104 of the semiconductor wafer 106. As is known in the art, the energy sources 103 used to generate the probe beams 102 can include various types of sources of energy such as a laser, a light source, a white light source, a x-ray source and other energy sources. The energy output by these sources is then focused onto the area 104 using known techniques. As shown in FIG. 1 for example, probe beam 102 is reflected to the sample by a mirror 105 and is focused onto the area 104 using a lens 111.

The energy reflected off the sample 106 is directed to either imaging system 110 or the measurement system 107 by a beam splitter 113. Typically, the imaging system 110 will operate using light energy reflected off the sample 106. The imaging system can include for example, a video camera, and a microscope. The measurement system 107 can include such devices as, for example, an interferometer, a reflectometer, an ellipsometer, an FTIR spectrometer, or any other type of spectrophotometer. Typically, the measurement system will be positioned and aligned such that it will make measurements of the area on the sample 106 which is aligned with the center of the field of view of the imaging system 110.

The metrology systems also includes an adjustable stage 109 for supporting the wafer 106. The stage 109 typically includes a chuck 108 which supports the sample wafer 106, a track 114, and a mounting system 115 which couples the chuck to the track such that motors that can change the position of the chuck 108 and the sample 106 relative to track 114 and the imaging system 110. The stage 109 is coupled to the processor system 116, such that in response to signals from the processing system the stage adjusts the position of the chuck 108 and thereby the sample 106 relative to the imaging system 110. Additionally, motors can be included in the mounting system 115 which can rotate the chuck 108 relative to the imaging system 110. Various types of stages are known in the art, and provide for different types of motion combinations, and coordinate systems. Examples of such stages include full X, Y stages; R/Theta stages (also referred to as polar coordinate stages); ½X-½Y plus Theta stages, and theta stages. A full X, Y stage allows the wafer to be the length of the diameter of the wafer in both the X and Y direction. R/Theta stages allow the wafer to be moved in the along one axis a distance equal to at least the radius of the wafer, and the stage can be rotated 360°. The ½X½Y theta stage allows the wafer to be moved some distance in both the X and Y direction, and allows for rotation in 90° intervals. The pure theta stage provides 360° rotation and is used in conjunction with an optics system that can move linearly relative to the theta stage. The movement of the stages are controlled by a processor system 116, so that the wafer sample can be moved to various positions relative to the probe beams 102 and the imaging system 110, so that all areas of the wafer can be analyzed. These stages are used in combination with the imaging system 110, and permit the user to visually inspect the wafer and to visually position the wafer with respect to the imaging system 110. The measurement tools which are also incorporated into the metrology system (not shown) will typically measure the area 104 of the sample 106 which is aligned with the imaging system 110.

In prior systems, the operator typically controlled the movement of the stage 108 and hence the position of the wafer 106 with respect to the probe beams 102 and the imaging system 110, using a joystick or a trackball, which was coupled to a processor system 116. In these systems the operator was presented with a target on an image view displayed on the monitor 112, and movement of the joystick caused the stage to move in the selected direction. Some prior references have discussed providing software controls, which provide the user to with the ability to move the sample being inspected. See International Application WO 00/57127, Method and Apparatus for Wafer Metrology; and U.S. Pat. No. 6,320,609 B1, System Using Polar Coordinate Stage and Continuous Image Rotation to Compensate for Stage Rotation (both of these references are incorporated herein by reference). Some prior art system also provided for software controls that showed an image of the sample and allowed the user to input selected X Y coordinates, or R—theta coordinates, and then in response to inputting the coordinates the stage moved the sample so that a different area on the sample could be viewed.

Many prior operator controls require that a user apply a constant input to move the chuck and the sample supported on the chuck. For example, using a joystick, the user would need to hold the joystick in a particular position indicating that motion is desired in a selected direction, but when the user released the joystick, the stage would stop moving. These prior systems typically did not a provide a way for a user to select an area on a sample, and then have the processor system cause the sample to be moved into a position for viewing and measurement.

What is needed is a user interface which provides an image of the wafer being analyzed, and integrates this image with a complement of software user interface tools which are displayed on a monitor and allow the user to control to the position of the chuck, and thereby easily position, and orientate the wafer with respect to the imaging system.

### SUMMARY

In accordance with an aspect of the invention a processing system integrates user interface tools with an image of the wafer shown on a monitor display. In one embodiment a system includes an adjustable stage which supports a sample to be inspected, and an imaging system that generates imaging signals. This system further includes a processor system coupled to the adjustable stage, which can control the position of the sample relative to the imaging system. The processor system is coupled to the imaging system such that it receives the imaging signals. A user input device is coupled to the processor system. The processor system generates a display which includes a first pane, where the first pane shows a first image of the sample, and generates a pointer which is displayed over the first image. A user can use the user input device to change the position of the pointer over the first image, and select a first area on the sample based on the position of pointer relative to the first image. The processor system then determines a first distance to move the sample relative to the imaging system.

In another embodiment a metrology system used to analyze samples, includes an adjustable stage which supports a sample to be inspected, and an imaging system that generates imaging signals. The system also includes a processor system coupled to the adjustable stage which can control the position of the stage relative to the imaging system, and the processor is coupled to the imaging system to receive the imaging signals. In this embodiment the processor system generates a display which includes a first pane which shows a geometric shape that corresponds to a shape of the sample and in response to user inputs, the processor moves a pointer over the geometric shape, and wherein in response to a selection signal input to the processor system, the processor system determines a first distance to move the sample relative to the imaging system, and generates movement signals causing the stage to move the sample a first distance.

In another embodiment the metrology system used to analyze samples, includes a stage which supports a sample to be analyzed, and a processor system coupled to the adjustable stage which controls the position of the sample. The processor system also generates a display which includes an angle step control field, and in response to user input, the processor system determines an angle of step rotation, then in response user input the processor system sends a signal to the stage causing the sample to rotate an amount equal to the determined angle of step rotation.

Another embodiment is a method which includes displaying a first image of a sample being inspected, and a pointer in a position over an area of the first image. In this embodiment a selected area on the sample is determined based on a position of the pointer when a user selection signal is transmitted, and then a selected area is moved a first distance to a new position relative to the imaging system.

Another embodiment includes displaying a geometric shape which corresponds to the shape of the sample being inspected, and displaying a pointer positioned over a portion of the geometric shape. In this embodiment based on the position of the pointer a selected area is determined, and then a first area of the sample which corresponds to the selected area on the geometric shape is determined, and the position of the first area on the sample relative to the imaging system is changed.

Another embodiment provides a method of moving a sample in a metrology system. The method includes displaying a first set of visual information which corresponds to a sample being analyzed using the metrology system, and positioning a pointer over the first set of visual information. This visual information could include, for example, an image of the sample, or an image of a portion of the sample being analyzed, or could include coordinate information corresponding to a location on the sample, or a geometric shape which corresponds to the shape of the sample. This method also includes transmitting a first selection signal when the pointer is positioned over a selected area of the first visual information, and moving the selected area a first distance, where this first distance is based on a position of the selected area.

Another embodiment provides a method of controlling the motion of an adjustable stage in a metrology system. This method includes displaying a pointer over an image of a sample supported on the stage, and moving the pointer to a desired measurement area on the image and generating a trigger signal in response to input from a user, and then moving the stage to bring the desired measurement spot to a position so that the probe beam will strike the measurement area.

Another embodiment includes a method of changing an image displayed by an imaging system of a metrology system used to inspect samples. This method includes displaying a pointer on an image of a sample, and moving the pointer to a desired area on image of the sample, and generating a trigger signal in response to input from a user. In response to the trigger signal the position of the imaging system relative to sample is changed, such that the desired area is displayed in a new position in a refreshed image of the sample.

### BRIEF DESCRIPTION OF THE DRAWINGS

FIG. 1 shows a metrology system of the prior art.

FIG. 2 shows a view of the display and interface of the present invention.

FIG. 3 shows another view of the display and interface of the present invention.

FIG. 4 shows a flow chart of the process used by move the wafer in response to user interaction with the user interface of the present invention.

FIG. 5 shows another view of the display and interface of the invention.

### DETAILED DESCRIPTION

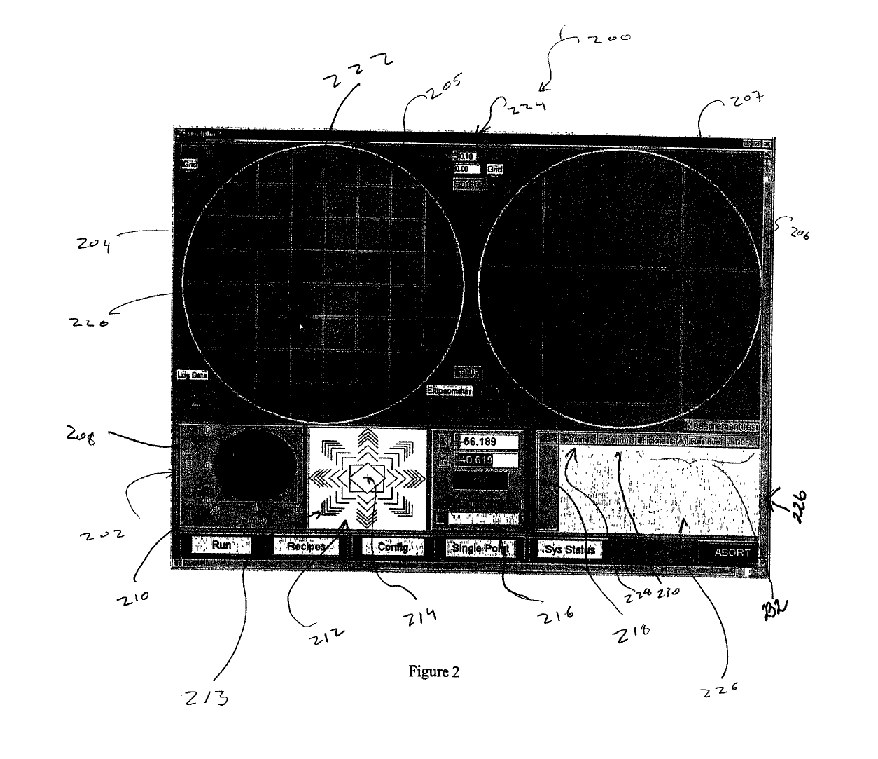

The invention provides for a software user interface tool that allows a user to efficiently and intuitively change the position of a sample being viewed relative to an imaging system. In one embodiment the user is provided with an interface 200 shown in FIG. 2. The interface 200 can include a number of elements, which are discussed in detail below. The interface 200 is generated by the processor system 116, which is programmed using software to generate and display a number of user interface tools on the monitor 112 of the system. The processor system 116 also displays images 205 and 207 of the wafer 106, based on signals that the processor 116 receives from the imaging system 110.

The user interface 200 allows the user to visually inspect a wafer sample 106, and simultaneously displays panes on the monitor 112 that include navigation tools. In one embodiment these tools include a rough positioning pane 202. The rough positioning pane 202 facilitates the selection of an area to view on a wafer. Specifically, the rough positioning pane 202 addresses the need to move the wafer being inspected a relatively large distance, which is generally a distance greater than that which can be displayed in the field of view of the images 205 and 207 shown in panes 204 and 206; although, it is not necessary that the distance be greater than that shown in the field of view.

In the rough positioning pane 202 the user can position a pointer (shown as 208) on the location of the geometric shape 210 which corresponds to the shape of the sample 106 which is being analyzed. The processor system 116 translates the pointer 208 location with respect to the geometric shape 210 into a corresponding position on the sample wafer 106. For example, when the pointer 208 is positioned in the upper left hand area of the geometric shape 210, this would correspond to the upper left hand area of the sample 106. Once the processor system has determined a location on the sample 106 being evaluated which corresponds to an area selected by a user on the geometric shape 210, the processor system 116 generates movement signals which are transmitted to the mounting system 115, and in response to these movement signals the position of the wafer 106 is moved such that the selected area is closer to a focal point of the imaging system 110.

It should be noted that as shown in the embodiment of the invention in FIG. 2, the geometric shape 210 which corresponds to the shape of the wafer sample 106 being evaluated is not an actual image of the wafer surface as is shown in images 205 and 207 of view panes 204 and 206. If the field of view of the imaging system 110 were wide enough, then an actual image of the sample could be used in place of the geometric shape 210 shown in FIG. 2. The geometric shape 210 does not need to directly correspond to the shape of the sample wafer. For example, wafers will typically have a notch along the outer circumference of the sample, and this need not be reflected in the corresponding shape. In fact the corresponding geometric shape 210 could be quite different from the shape of the sample, so long as some correlation can be made between the geometric shape and the sample being inspected.

In one embodiment, a user can position a pointer 208 anywhere in the geometric shape 210 using a user input device 120, such as a mouse or keyboard. When the user clicks a button on a mouse while the pointer positioned over the geometric shape 210, it will trigger the processor system 116 to determine the area on the wafer which corresponds to the position of the pointer 208 relative to the shape 210, and then transmit movement signals causing the stage 109 to change the position of the chuck 108 relative to the imaging system 110, such that it brings the selected area on the wafer to a position such that it will appear close to the center of the image 205. Note that in many embodiments the imaging position, will coincide with a measurement position. The location of the pointer 208 is interpreted by the processor system 116 and control signals are generated processor system 116 for moving the stage 108. These signals generated by the processor system are transmitted to the stage causing the stage to move the chuck 108 relative to the imaging system 110. Since the signals are generated by the processor system 116, the software used to program the processor system 116 can be designed such that the user interface can provide any type of coordinate system transformation, and a wide range of stage configurations can be used.

In this embodiment a fine control pane 212 is also provided. The fine control pane 212 includes arrow like features 213, and allows for fine control of the wafer sample 106 and stage 108 position. The user can input signals using a user input device 120, such as a mouse or keyboard, to position a pointer 208 anywhere within the white area of the fine control pane 212, and as long as a button (in one embodiment, this is the left mouse button) is pressed, the processor system 116 will generate movement signals which cause the stage 108 to be moved such that the wafer moves underneath the probe beams 102 and the imaging system 110 in the direction indicated by the arrows of the fine control pane 212. In one embodiment, all directions including those in between the arrows are allowed. The arrow features 213 are provided for general movement guidance. The movement of the stage is determined by the pointer's position, when a button is pressed, relative to the center 214 of the fine control pane 212. The speed of the stage 108 motion, and therefore the wafer sample 106 motion is controlled by the distance of the pointer from the center 214 of the fine control pane 212. The scale of the speed can be controlled in the slide control 216 shown at the right of FIG. 2 and labeled “Trackball Response”. In one embodiment, the speed varies linearly with the distance of the pointer 208 from the center 214. Other embodiments could allow for non-linear speed of movement based on the distance of the pointer 208 from the center 214.

In one embodiment a coordinate control pane 218 is also be provided. In the coordinate control pane two coordinates (an X coordinate and Y coordinate) can be entered which describe the coordinates of a point on the wafer. Upon entry of the X and Y coordinates, and confirmation, the processor system 116 generates signals causing the stage to be moved such that the wafer is positioned under the probe beam 102, according to the entered X Y coordinate points. In one embodiment this consists of inputting the X Y coordinates and pressing an Enter key on a keyboard, or as shown in FIG. 2, the user can also position a pointer over the “Go” button in the pane 218 and click a mouse button causing the coordinates to be entered.

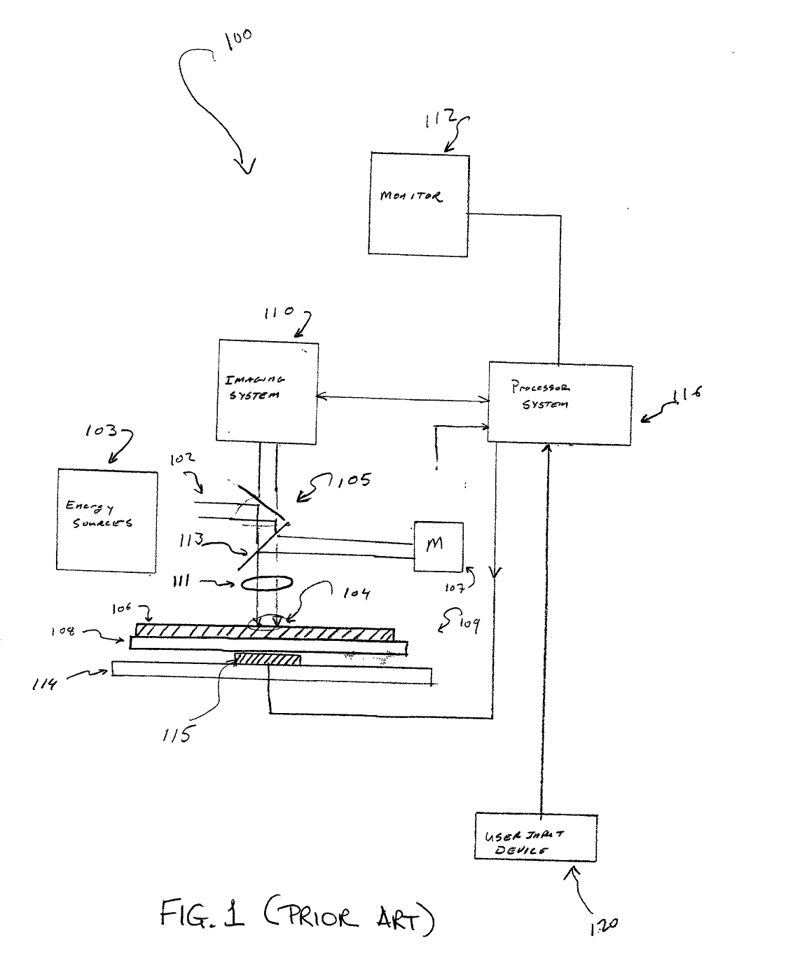

Image view pane 204 shows low magnification image 205 of a portion of the wafer, and image view pane 206 shows a high magnification image 207 of a portion of the wafer. These images 205 and 207 are generated using the image system 110 which transmits the image signals to the processor system 116. The processor system 116 then generates digitized images 205 and 207 which are displayed in the image view panes 204 and 206. These images can be digitized using for example a frame grabber, or the image can be recorded in digital form directly if a digital camera is used by the imaging system 110. It should be noted that the processor system 116 is shown generically in FIG. 1, and in an embodiment of the invention could consist of multiple processors at multiple locations in the metrology system 100. For example the imaging system 110 may include a processor which processes image signals prior to transmitting the signals to another processor. The processor system 116 may also include multiple processors which are dedicated to generating movement signals to be transmitted to the mounting system 115.

The following example helps to illustrate the use of image panes 204 and 206 in positioning the wafer. In pane 204 the measurement area of interest is the shaded box 220 in the left side of the low magnification image 205. Using a user input device 120, such as a mouse or a keyboard, a user can position a pointer 222 such that it is over the shaded box 220 as shown. A predefined event such as mouse click, or a pressing of a particular key combination, sends a selection signal to the processor system 116, which triggers the processor system 116 to execute an automatic positioning routine.

As part of the positioning routine, the processor system 116 determines the coordinates of the pointer 222 with respect to the image 205 shown in the pane 204. Specifically, when the user uses the input device 120 (e.g. a mouse button is clicked) to input a selection signal indicating that an area 220 has been selected for movement closer to the center of the image shown in pane 204, the processor system 116 determines the area of the wafer sample 106 which corresponds to the position of the pointer 222 relative to the image shown in the pane 204. Once the selected area of the wafer has been determined the processor system generates movement signals causing the stage 109 to move the chuck 108 such that selected area on the wafer 220 will be moved closer to the center of an image pane 204, and positioned such that the measurement system can take measurements on the selected area.

The image 205 shown in the low magnification pane 204 corresponds to the field of view of the imaging system 110, for a given amount of magnification. Typically, the area of the wafer shown in pane 204 will be a small percentage (e.g. in the range of 0.01%) of the overall area of the sample wafer. The image 207 shown in high magnification pane 206 has a smaller field of view than the field of view of the image shown in pane 204 (i.e. in the range of 0.001%). In one embodiment the field of view of the image 207 is approximately the center area of the image 205.

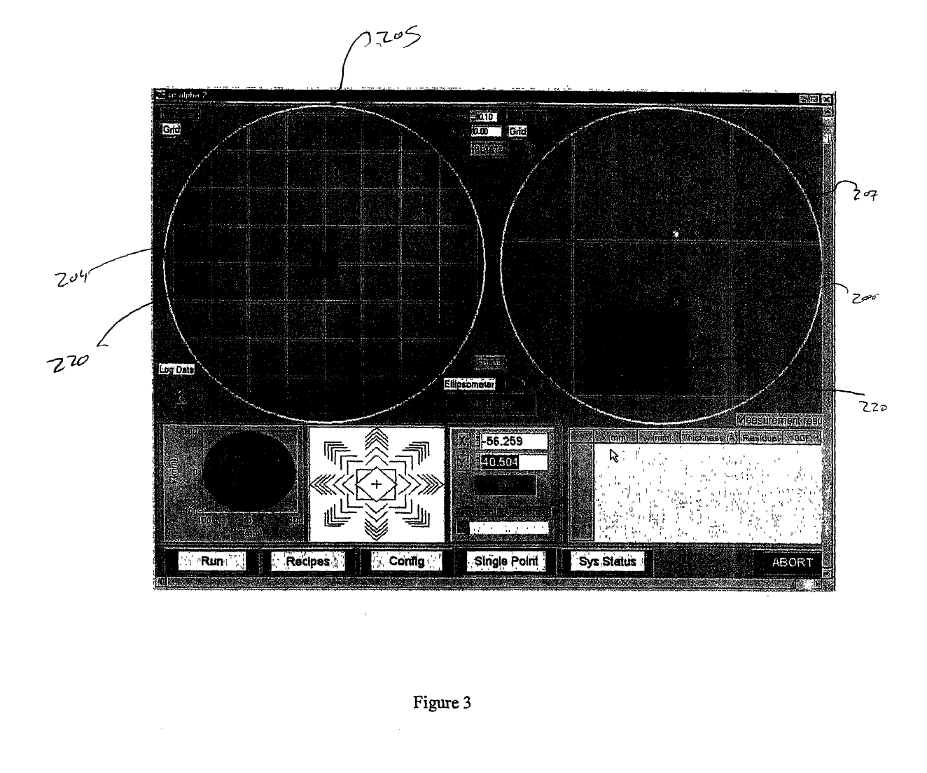

The fact that the field of view is significantly less in pane 206 versus pane 204 is apparent when one considers FIGS. 2 and 3. In FIG. 2 the area which is selected by a user 220 is shown, and it is positioned some distance from the center of the image 205. The image 207 in the high magnification does not show the selected area 220 as it is outside of the field of view of the optical system 110 for the given level of magnification.

FIG. 3 shows panes 204 and 206 after the stage has been moved in response to the user selecting area 220, and the images 205 and 207 have been refreshed to reflect the fact that the wafer position has changed relative to the imaging system 110. At this point the selected area 220 is located at the center of image 205. The selected area 220 is now also brought into the field of view shown in image 207. (It should be noted that for the embodiment used to generate FIGS. 2 and 3, the center of the camera view pane 204 (low-magnification) and camera view pane 206 (high-magnification) images are not exactly aligned to each other, which results in the selected site 220 (shaded box) not being in the center of the image 207 shown in pane 206.

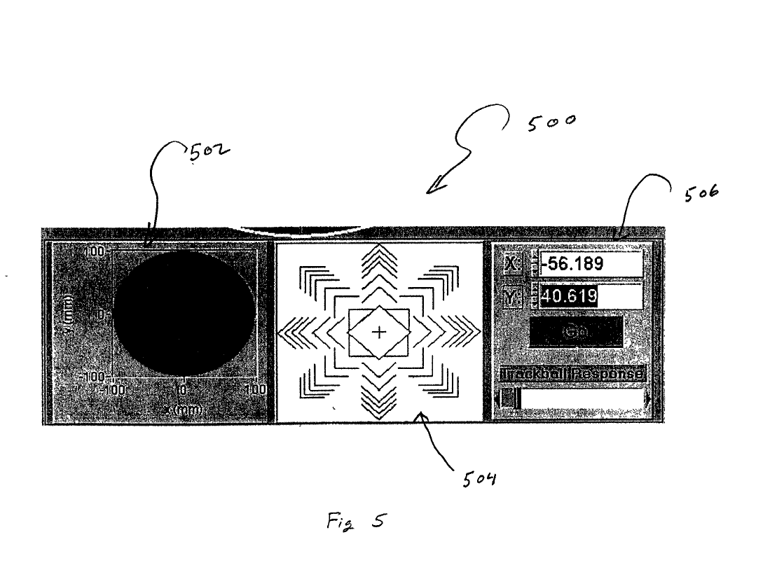

While the exemplary embodiment discussed herein includes a low-magnification pane 204 and high-magnification pane 206, other embodiments could be implemented providing for more or less than two panes for displaying magnified images. Aspects of the invention could be implemented without a display of an image of a sample being analyzed. For example, an alternative embodiment is shown in FIG. 5. In FIG. 5 the user interface 500 provides a rough positioning pane 502, and a fine positioning pane 504. The interface 500 also provides a coordinate control pane 506. The panes in interface 500 operate in a manner similar to that described above in connection with interface 200, but instead of operating in conjunction with an imaging system to, among other things, display images of selected areas of a sample in image panes, the interface is used to position the sample being inspected so that desired areas can be moved relative to a measurement device such that the sample is positioned for measurement of selected areas on the sample, but there need not be a corresponding image displayed in an image pane.

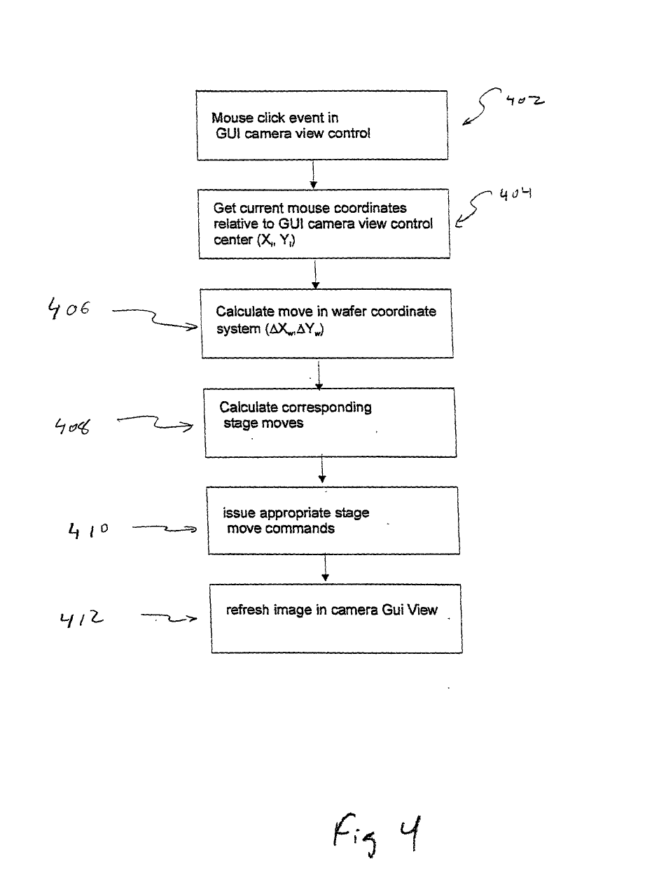

FIG. 4 is a flow chart illustrating steps of the positioning routine executed by the processor system 116. At step 402 the processor system 116 receives a selection signal from the user input device 120 indicating that the user has selected an area in low magnification view pane 204. As discussed above, in one embodiment this signal would be generated by clicking a mouse button. At step 404, in response to receiving the selection signal the processor system 116 determines the position of the pointer 222 relative to the image 205. Step 406 is the calculation of the movement necessary in terms of the wafer coordinate system to bring the selected area 220 to the center of the image 205. In one embodiment calculation of the ΔX and ΔY is done relative to the X and Y position of the area which is currently at the center of the image 205. Once ΔX and ΔY have been determined the actual amount of movement of the stage relative to the image, is in part a factor of the degree of magnification of the image 205.

Once the amount of movement necessary in terms of wafer coordinates has been determined the next step 408 is to determine the necessary movement in terms of stage coordinates to effectuate the desired movement of the wafer 106. The calculation of the stage move of a full X Y stage can be derived from the ΔX and ΔY with out the need to translate to new coordinate system. In some cases for a ½X½Y theta stage the stage will need to rotate if the selected site is in a different quadrant of the wafer. For stages such as a polar coordinate stage, the ΔX and ΔY calculated at step 406 will need to be translated into a linear movement of the polar coordinate stage and into Θ rotation of the polar coordinate stage. In some cases it may also be desirable to account for an offset between the center of rotation of the polar coordinate stage and the field of view of the imaging system of the metrology system. A detailed discussion of a method for determining such an offset is discussed in commonly assigned, pending application serial number (pending) filed on Jan. 11, 2002, titled SYSTEM AND METHOD FOR FINDING THE CENTER OF ROTATION OF AN R-THETA STAGE (attorney docket TWI-14710, which is hereby incorporated by reference in its entirety.

At step 410, commands are sent to the mounting system 115 which result in the desired movement of the stage. After the stage 108 has been moved to the desired position, the images 205 and 207 shown in panes 204 and 206 are refreshed, step 412, to reflect the new position of the wafer.

The steps discussed above in connection with FIG. 4 are analogous to the approach which would be used in connection with the rough positioning pane 202 in response to a user using a pointer to select an area on the geometric shape 210 (e.g. positioning the mouse over a desired location on the geometric shape 210 and pressing a specified button on the mouse) except that the coordinates of the pointer 208 would be determined with respect to geometric shape 210, rather than an image shown in pane 204. Once an area is selected on the geometric shape 210, that area is used to identify a corresponding area on the wafer 106. As would be obvious to one of skill in the art, the specific implementation of the above steps is dependent on the wafer coordinate system used as well as the stage coordinate system and stage motion system. Also, while the above discussion is presented in the context of a system where the chuck is moved to reposition a sample, the system and method discussed herein could also be utilized in a system where the stage remains in fixed position, while the imaging system and measurement system move to different positions relative to the stage. Thus, when discussing the movement of the wafer sample or chuck relative to the imaging system, from a practical point of view this would apply to either a system where the chuck is moved, or where the imaging system is moved.

The embodiment shown in FIG. 2 shows additional features of the user interface generated by the processor system 116. An incremental rotation tool 224 allows a user to incrementally rotate a wafer sample 106 being analyzed. In the embodiment shown in FIG. 2 the incremental rotation tool 224 includes a field “Angle Step” which allows a user to input a desired amount of rotation per step. As shown in FIG. 2 the incremental steps would be 0.1 degree. The user can either input the desired incremental step amount, or can use the up down arrows to cause the step amount to be increased or decreased. The incremental rotation tool 224 also provides a field (the “Angle” field as shown in FIG. 2) where a user can directly input the amount of rotation desired for the wafer. After the user has input the desired value in either the “Angle Step” or “Angle” field, the rotation can be effected by the user using the mouse to click on the software button “Rotate”. The ability to specifically control, and incrementally control, the amount or rotation of the stage 108 can be very helpful where the user would like to align grid patterns which are often present of sample wafers, with the orientation of the wafer images 205 and 207 shown in panes 204 and 206.

The embodiment shown in FIG. 2 also includes a measurement results pane 226. The measurement results pane 226 can display measurement result information for different locations on a wafer sample 106 being evaluated. As shown pane 226 includes columns 228 and 230 for identifying a particular position on the wafer. Additional columns 232 are provided for displaying specific measurement information which corresponds the position identified in columns 228 and 230. It would be possible to position a pointer on a particular row which corresponds to a given x y coordinate for a position shown in pane 226, and to select a particular row. In response to this selection the processor system 116 can use the x y coordinate information in columns 228 and 230 to move the wafer such that the corresponding area on the wafer can be shown in the panes 204 and 206, and brought in position for doing further measurements.

One advantage of this invention over the conventional implementation using actual hardware in form of a trackball or joystick is the reduction of parts, and a reduction of footprint necessary for its implementation, since a keyboard, mouse, monitor and computer are used in these systems anyway. In addition, this approach is very intuitive and ergonomically very desirable. Further the software tools described herein provide the user with a wide range of ways to move the wafer to new positions, which allow the user to quickly and efficiently move the wafer to desired positions. It should also be noted that while one use for the system described herein is for analyzing sample semiconductor wafers, samples of other materials could also be evaluated using the present invention. Additionally, it should be noted that the present invention can be implemented utilizing a wide range of different embodiments, including a variety of different stage configurations and optics configurations.

While the method and apparatus of the present invention has been described in terms of its presently preferred and alternate embodiments, those skilled in the art will recognize that the present invention may be practiced with modification and alteration within the spirit and scope of the appended claims. The specifications and drawings are, accordingly, to be regarded in an illustrative rather than a restrictive sense. Further, even though only certain embodiments have been described in detail, those having ordinary skill in the art will certainly understand that many modifications are possible without departing from the teachings thereof. All such modifications are intended to be encompassed within the following claims.

What is claimed is:

1. A metrology system used to analyze samples, including:
an adjustable stage which supports a sample to be inspected;
an imaging system that generates imaging signals;
a processor system coupled to the adjustable stage, wherein the processor system can control the position of the sample relative to the imaging system, and wherein the processor system is coupled to the imaging system such that it receives the imaging signals;
a user input device coupled to the processor system; and
wherein the processor system generates a display which includes a first pane, wherein the first pane shows a first image of the sample, and generates a pointer which is displayed over the first image, and wherein a user can use the user input device to change the position of the pointer over the first image, and select a first area on the sample based on the position of pointer relative to the first image, and wherein the processor system determines a first distance to move the sample relative to the imaging system.

2. The metrology system of claim 1, wherein processor system transmits a movement signal to the stage and in response to the movement signal the stage moves the sample a first distance to a second position.

3. The metrology system of claim 2, wherein after the stage has been moved to the second position, the processor system refreshes the first image of the wafer, and wherein the refreshed first image shows the wafer in the second position, wherein the second position is such that the first area is displayed in approximately a center of the refreshed first image of the wafer.

4. The system of claim 1, wherein the processor system generates a second pane which is displayed at the same time as the first pane, and wherein the second pane includes a geometric shape that corresponds to the shape of the sample, and in response to user inputs the processor system moves a pointer over the geometric shape, and determines a first position on the geometric shape based on the position of the pointer over the geometric shape, and in response to a selection of a first position on the geometric shape the processor determines a second distance to move the sample relative to the imaging system.

5. The metrology system of claim 1, wherein the processor system generates a second pane which shows a second image of the sample.

6. The metrology system of claim 5, wherein the second image shows a portion of the sample shown in the first image, and wherein the portion of the first image shown in the second image is approximately a center area of the first magnified image.

7. The metrology system of claim 3, wherein the processor system generates a second pane which shows a second image of the sample, wherein the second image includes a portion of the first image.

8. The metrology system of claim 7, wherein the portion of the first image shown in the second image is approximately a center area of the first image, and wherein after the stage has been moved in response the user selecting a first area on the sample, the second image is refreshed.

9. The metrology system of claim 1, wherein the processor system generates a second pane having a center point, and in response to user input moves a pointer in the second pane, and wherein in response to a selection signal input to the processor system the processor system transmits movement signals to the stage, wherein the movement signals are based on the position of the pointer relative to the center point of the second pane.

10. A metrology system used to analyze samples, including:
an adjustable stage which supports a sample to be inspected;
an imaging system that generates imaging signals;
a processor system coupled to the adjustable stage which can control the position of the stage relative to the imaging system, and coupled to the imaging system to receive the imaging signals; and
wherein the processor system generates a display which includes a first pane which shows a geometric shape that corresponds to a shape of the sample and in response to user inputs, the processor moves a pointer over the geometric shape, and wherein in response to a selection signal input to the processor system, the processor system determines a first distance to move the sample relative to the imaging system, and generates movement signals causing the stage to move the sample a first distance.

11. The metrology system of claim 10 wherein the first distance is determined by the processor system based on the position of the pointer relative to the geometric shape.

12. A metrology system used to analyze samples, including:
a stage which supports a sample to be analyzed;
a processor system coupled to the adjustable stage which controls the position of the sample; and
wherein the processor system also generates a display which includes an angle step control field, and wherein in response to user input, the processor system determines an angle of step rotation, and in response user input the processor system sends a signal to the stage causing the sample to rotate an amount equal to the determined angle of step rotation.

13. In a metrology system, a method of adjusting the position of a sample relative to an imaging system of the metrology system, the method comprising:
displaying a first image of a sample being inspected;
displaying a pointer in a position over an area of the first image;
determining a selected area on the sample based on a position of the pointer when a user selection signal is transmitted; and
moving the selected area on the sample a first distance to a new position relative to the imaging system.

14. The method of claim 13 comprising refreshing the first magnified image sample, after moving the selected area on the wafer to the new position.

15. The method of claim 13 wherein the new position is such that the selected area is displayed closer to a center area of the refreshed first image than the selected area was in the first image prior to the sample being moved to the new position.

16. The method of claim 13 further comprising:
displaying a second image of the sample at the same time as the displaying of the first image.

17. The method of claim 16 further comprising refreshing the first image and the second image after the selected area is moved to the new position.

18. The method of claim 16 wherein the second image displays an area of the sample which is shown at approximately a center area of the first image.

19. The method of claim 13 further comprising:
displaying a second pane at the same time as the first pane, wherein the second pane includes a geometric shape that corresponds to the shape of the sample;
displaying a pointer over the geometric shape;
determining a selected area on the sample based on the position of the pointer relative to the geometric shape; and
moving the sample a first distance relative to the imaging system, where the first distance is determined based on the location of the selected area.

20. The method of claim 13 wherein the first distance is determined based on the position of the pointer when the selection signal is received by the processor system.

21. In a metrology system for analyzing samples, a method of allowing a user to adjust the position of a sample being inspected relative to an imaging system, the method comprising:
displaying a geometric shape which corresponds to the shape of the sample being inspected;
displaying a pointer positioned over a portion of the geometric shape;
determining a selected area on the geometric shape based on the position of the pointer;
determining a first area of the sample which corresponds to the selected area on the geometric shape; and
changing the position of the first area on the sample relative to the imaging system.

22. The method of claim 21 further comprising changing the position of the first area by moving the first area a first distance relative to the imaging system, where the first distance is determined based position of the selected area on the geometric shape.

23. A method of moving a sample in a metrology system, the method comprising:
displaying a first set of visual information which corresponds to a sample being analyzed using the metrology system;
positioning a pointer over the first set of visual information;
transmitting a first selection signal when the pointer is positioned over a selected area of the first visual information; and
moving the selected area a first distance, wherein the first distance is based on a position of the selected area.

24. The method of claim 23 wherein the first set of visual information includes an image of a first portion of the sample.

25. The method of claim 23 wherein the first set of visual information includes a geometric shape that corresponds to the shape of the wafer.

26. The method of claim 23 further comprising displaying a field where a user can input a desired angle step rotation, and in response to the user input rotating the sample the desired angle step rotation.

27. The method of claim 23 further comprising:
displaying a first pane having a center area while the first information is being displayed;
displaying a pointer over the first pane;
moving the pointer to different positions in the first pane in response to user input;
moving the sample in a first direction in response to a second selection signal, wherein the first direction is determined by the position of the pointer in the first pane when the second selection signal is generated.

28. A method of controlling the motion of an adjustable stage in a metrology system, said adjustable stage supporting a wafer, said metrology system including a probe beam which is directed to reflect off a measurement area on the sample during a measurement step, said tool metrology system including an imaging system for displaying an image of the wafer, said method comprising the steps of:
displaying a pointer on the image of the sample;
moving the pointer to a desired measurement area on the image and generating a trigger signal in response to input from a user; and
moving the stage to bring the desired measurement spot to a position so that the probe beam will strike the measurement area.

29. A method as recited in claim 28 wherein a center of a field of view of the imaging substantially corresponds to the measurement spot.

30. A method of changing an image displayed by an imaging system of a metrology system used to inspect samples, comprising:
displaying a pointer on an image of a sample;
moving the pointer to a desired area on image of the sample, and generating a trigger signal in response to input from a user; and
changing the position of the imaging system relative to sample, such that he desired area is displayed in a new position in a refreshed image of the sample.

31. The method of claim 30 wherein in the new position the desired area of the sample is displayed at approximately a center of the refreshed image of the sample.

32. The method of claim 31 wherein characteristics of the desired area of the sample are measured after the desired area is in the new position.
